(19) United States
(12) Patent Application Publication
(10) Pub. No.: US 2025/0240267 A1
(43) Pub. Date: Jul. 24, 2025

(54) TECHNOLOGY CONFIGURED TO ENABLE IMPROVED SECURE COMMUNICATION OVER A NETWORK

(71) Applicant: Etcetra Labs Pty Ltd, Buderim (AU)

(72) Inventors: John David Steelman Frakes, Beerwah (AU); Julian Dayle White, Buderim (AU)

(21) Appl. No.: 19/034,322

(22) Filed: Jan. 22, 2025

(30) Foreign Application Priority Data
Jan. 22, 2024 (AU) 2024900147

(51) Int. Cl. H04L 61/5007; H04L 9/08; H04L 9/32

(52) U.S. Cl. CPC H04L 61/5007; H04L 9/0891; H04L 9/3213

(57) ABSTRACT

Technology is configured to enable improved secure communication over a network. For example, in some embodiments, the technology enables software executing at one device to communicate via a network with software executing at a further device in a manner that provides a secure communications channel via dynamic IP address allocation.

### PRIORITY CLAIM

This application claims the benefit of the filing date of Australian Patent Application Serial No. AU2024900147, filed Jan. 22, 2024, for “TECHNOLOGY CONFIGURED TO ENABLE IMPROVED SECURE COMMUNICATION OVER A NETWORK,” the disclosure of which is hereby incorporated herein in its entirety by this reference.

### TECHNICAL FIELD

The present disclosure relates, in various embodiments, to technology configured to enable improved secure communication over a network. For example, in some embodiments, the technology enables software executing at one device to communicate via a network with software executing at a further device in a manner that provides a secure communications channel via dynamic IP address allocation. While some embodiments will be described herein with particular reference to those applications, it will be appreciated that the present disclosure is not limited to such a field of use and is applicable in broader contexts.

### BACKGROUND

Any discussion of the background art throughout the specification should in no way be considered as an admission that such art is widely known or forms part of common general knowledge in the field.

Security in network communications is a key challenge faced across a wide range of contexts in modern computing environments. While there are a range of known technology for facilitating secure communication (e.g., secure tunnelling, VPNs and the like), the applicability and/or effectiveness of those in various practical scenarios is often limited.

### BRIEF SUMMARY

It is an object of the present disclosure to overcome or ameliorate at least one of the disadvantages of the prior art, or to provide a useful alternative.

Example embodiments are described below in the section entitled “claims.”

One embodiment provides a method for enabling secure communications between an initiator device and a facilitator device, the method including execution of the following processes by the facilitator device: receiving from the initiator device data representative of a first addressing data set, the first addressing data set being representative of network addresses that are available at the initiator device; accessing a second addressing data set, the second addressing data set being representative of network addresses that are available at the facilitator device; performing a dynamic network address allocation process thereby to determine a prescribed set of network addresses for locking in respect of secure communications between the initiator device and the facilitator device, wherein the prescribed set of network addresses is determined based on processing of the first addressing data set and the second addressing data set; locking the prescribed set of network addresses for secure communications between the initiator device and the facilitator device, such that those network addresses are no longer available at the facilitator device; communicating to the initiator device data representative of the prescribed set of IP addresses; identifying that the initiator device has connected to the facilitator device via a secure communication based on the prescribed set of network addresses; and in response to identifying that the initiator device has connected to the facilitator device via a secure communication based on the prescribed set of network addresses, establishing secure communications with the initiator device via the prescribed set of network addresses.

One embodiment provides a method for enabling secure communications between an initiator device and a facilitator device, the method including execution of the following processes by the initiator device: providing to the initiator device data a representative of a first addressing data set, the first addressing data set being representative of network addresses that are available at the initiator device, wherein in response to receiving the first addressing data set the facilitator device performs the following processes: accessing a second addressing data set, the second addressing data set being representative of network addresses that are available at the facilitator device; performing a dynamic network address allocation process thereby to determine a prescribed set of network addresses for locking in respect of secure communications between the initiator device and the facilitator device, wherein the prescribed set of network addresses is determined based on processing of the first addressing data set and the second addressing data set; and locking the prescribed set of network addresses for secure communications between the initiator device and the facilitator device, such that those network addresses are no longer available at the facilitator device; receiving from the facilitator device data representative of the prescribed set of IP addresses; locking the prescribed set of network addresses for secure communications between the initiator device and the facilitator device, such that those network addresses are no longer available at the initiator device; and commencing secure communication with the facilitator device based on the prescribed set of network addresses.

Reference throughout this specification to “one embodiment,” “some embodiments” or “an embodiment” means that a particular feature, structure or characteristic described in connection with the embodiment is included in at least one embodiment of the present disclosure. Thus, appearances of the phrases “in one embodiment,” “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the present disclosure will now be described, by way of example only, with reference to the accompanying drawings in which:

FIG. 1A illustrates a method according to one embodiment, showing three phases of an overall secure communications process.

FIG. 1B illustrates an example framework for a use case of the method of FIG. 1A.

FIG. 2A illustrates a method according to one embodiment, showing steps relating to configuration of secure communications between two networked devices.

FIG. 2B illustrates a method according to one embodiment, showing an example trust establishment phase for the method of FIG. 1.

FIG. 2C illustrates a method according to one embodiment, showing an example network allocation phase for the method of FIG. 1.

FIG. 2D illustrates a method according to one embodiment, showing an example secure communications phase for the method of FIG. 1.

### DETAILED DESCRIPTION

The present disclosure relates, in various embodiments, to technology configured to enable improved secure communication over a network. For example, in some embodiments, the technology enables software executing at one device to communicate via a network with software executing at a further device in a manner that provides a secure communications channel via dynamic IP address allocation. While some embodiments will be described herein with particular reference to those applications, it will be appreciated that the present disclosure is not limited to such a field of use, and is applicable in broader contexts.

### Overview of Preferred Embodiments

Technology described herein is configured to enable secure communications between an initiator device and a facilitator device. The terms “initiator device” and a “facilitator device” are used to describe devices connected to a common network (for example, including the Internet), each device executing respective software instructions (i.e., computer executable code) which enables the performance of various methods/processes, including methods/processes relevant to the initiation and performance of secure communications. The nature of initiator and facilitator devices will vary widely between embodiments and implementation, with examples being:
The initiator device executes a software application (e.g., mobile app) which wishes to communicate securely with a server. For example, this might include a smartphone executing a banking app, a computer wishing to upload a periodic backup, etc.
The initiator device is a router, device, or controller establishing a secure connection with a server or remote system for SCADA, Building Management System (BMS), industrial/commercial control, smart city, or defense apparatus or infrastructure connectivity.
IoT out-of-band management.
Highly secured websites that require additional data security.
Secure file transfer services.
Examples may include moving of data over unsecured protocols and providing additional security for IoT, health information, web traffic, financial data.
The initiator device is an IoT device (e.g., a critical infrastructure/commercial-industrial IoT device) connecting to a local or remote management system.

The facilitator device is, in some embodiments, provided by a connection gateway running either in the cloud or in an organizations' existing environment. In some cases, this may be a virtualized image running on an in-office server, a cloud deployment (e.g., AWS, Azure, etc.), and so on.

The use of initiator/facilitator language rather than client/server language exemplifies that technology disclosed herein is point-to-point, and bypasses conventional client/server conventions. For example, connection may be “downwards” from a conventional “server” to conventional “client”—for example, with an IoT/BMS/Router device acting as facilitator device.

In broad terms, the technology described herein involves a dynamic network address allocation process, which makes use of data representing available network addresses (e.g., IP addresses) from both the initiator device and the facilitator device to determine a set of prescribed network addresses that are to be used for secure communications. Those prescribed addresses are “locked” by both the initiator device and the facilitator device for the purposes of secure communications between the initiator device and the facilitator device. The term “locked” in this sense means that the relevant addresses are no longer “available.”

Examples are described below with particular reference to current protocols involving the use of IP addresses. However, it should be appreciated that the present disclosure need not be construed in such a narrow manner, and may be applied in relation to a range of other network addressing protocols, including future versions of IP protocols, MAC addressing protocols, wired/wireless meshing or peer to peer protocols, and the like.

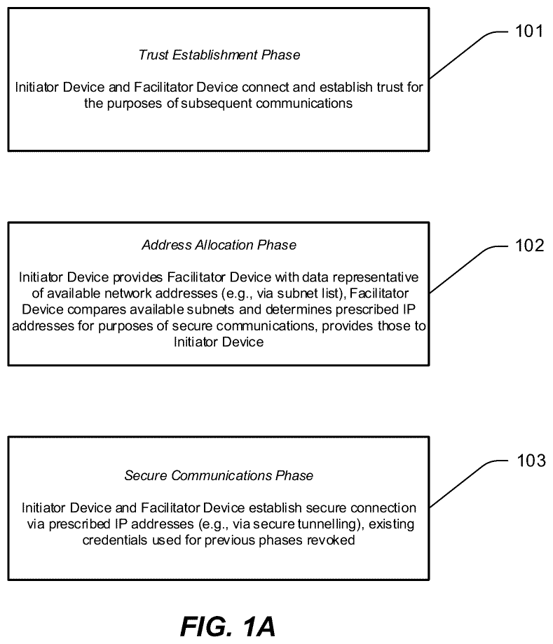

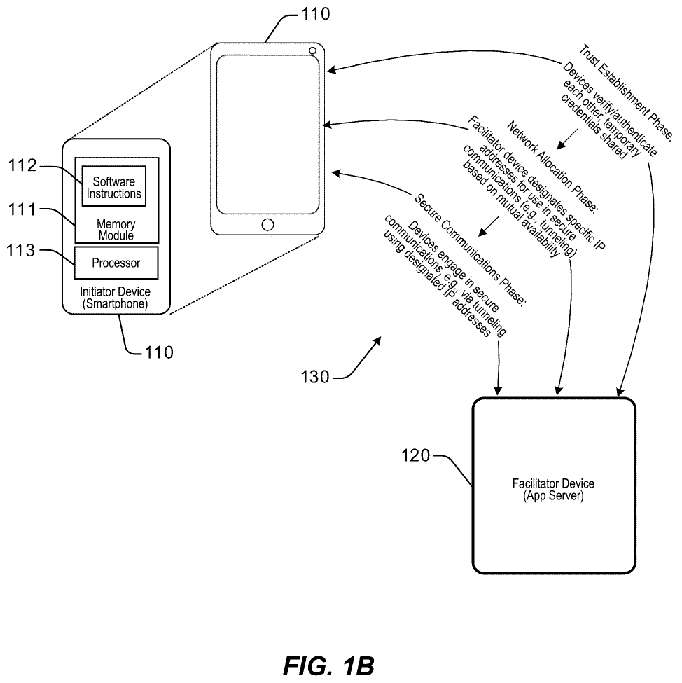

Referring to FIG. 1A, the overall process is split into three phases:
A trust establishment phase 101, whereby the facilitator device verifies the initiator device (and vice versa), thereby to establish verification and trust. For example, this may make use of a PKI public key (“SSL Cert”) or the like for the facilitator device, which may be pre-encoded in the initiator device, and compared with one presented upon initiation of communications. Access tokens, including limited use access tokens, may also be used. Examples are described in more detail below.
An address allocation phase 102. In this phase, the initiator device shares with the facilitator device identifies network addresses (e.g., IP addresses) that are available at both the initiator device and the facilitator device, and determines a prescribed set of those network addresses for locking in respect of secure communications between the initiator device and the facilitator device. The prescribed set is communicated to the initiator device.
A secure communications phase 103, whereby the initiator device and the facilitator device communicate securely (e.g., via encrypted communications) using the prescribed set of network addresses.

Upon completion of the secure communication phase, the network addresses that make up the prescribed set of network addresses are unlocked/released, meaning that they return to “available” status for the purpose of a subsequent iteration of address allocation phase 102.

Preferably, as part of the secure communications phase, a process is performed to revoke permissions granted via trust establishment phase 101. Accordingly, when a session of secure communications completes (either when terminated by either the initiator device or facilitator device, or subject to a predefined time period elapsing), it is necessary for an initiator device to complete phases 101 and 102 again prior to further secure communications.

FIG. 1B provides an example use case for the technology, where the initiator device is a smartphone 110 executing a banking app, and the facilitator device is an app server 120 for the banking app, these devices communicating over a network in the form of the Internet 130. The smartphone 110 includes a processor 113, and a memory module 111 that contains software instructions 112, those software instructions including an operating system, the banking app, and, within the banking app, software instructions that enable the initiator device processes relevant to phases 101-103. Software instructions executing at the facilitator device enable it to perform its relevant processes in relation to phases 101-103. In this manner, the devices are able to progress communications from trust establishment, through network address allocation, to secure communications (e.g., via tunnelling) as described herein.

It will be appreciated that the example use case of FIG. 1B is provided as context only, and is not intended to be limiting. Other example use cases include:
Communications between a router and a server.
Communications between a router and a further router.
Communications between a server and a further server.
Communications between a device in a Building Management System (BMS) and a BMS server.
Communications between an IoT device and a server.
More generally, communications between two devices that need single-use secure connectivity; or continual connectivity that reflects the single-use nature of the connections.

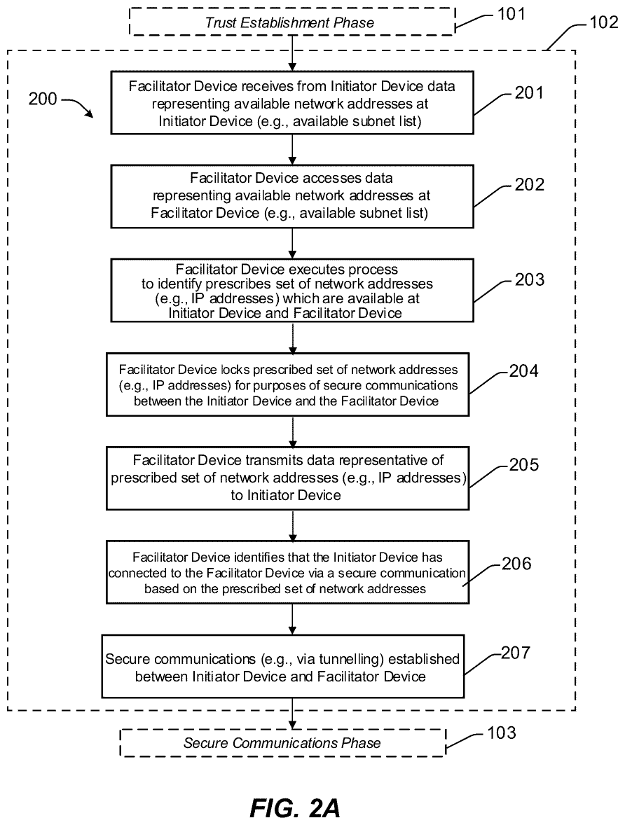

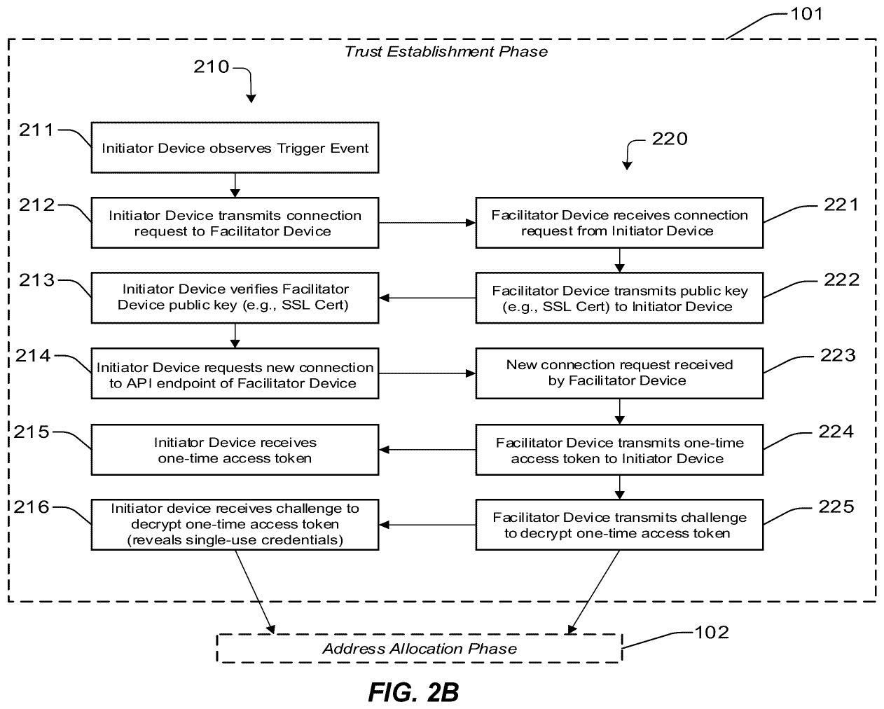

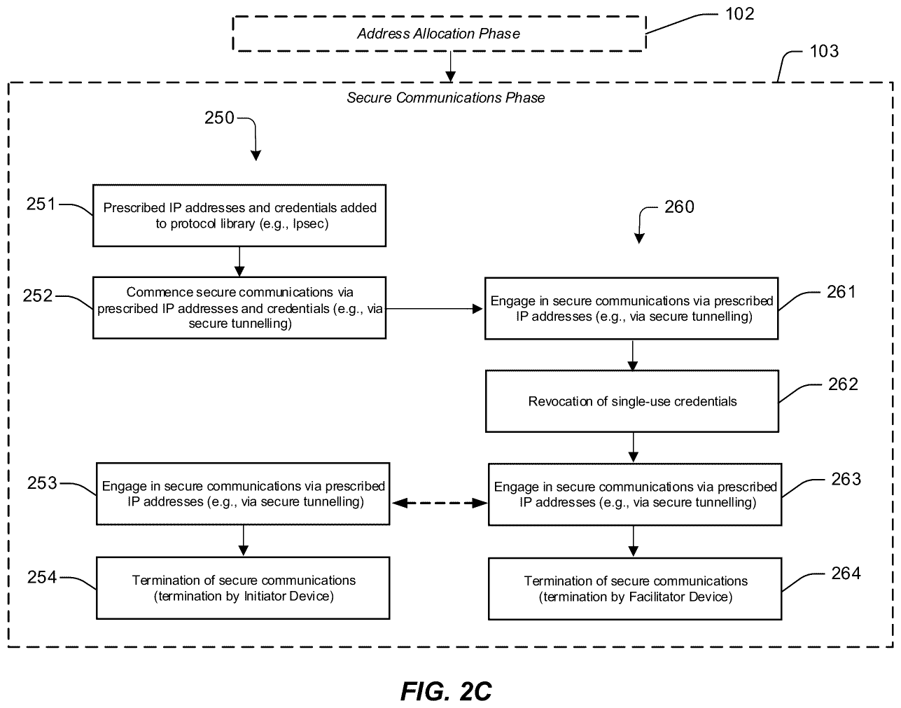

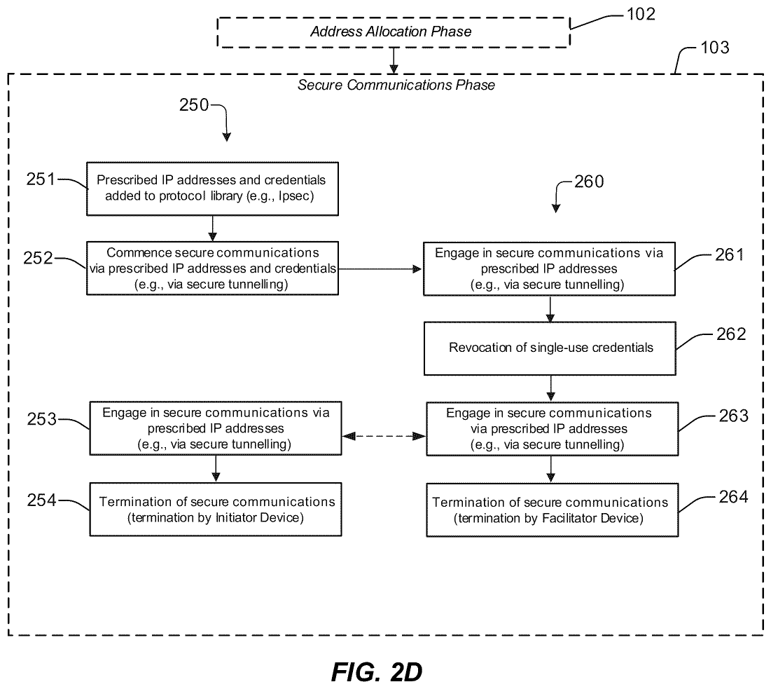

The address allocation phase 102 is of primary importance to the working of the technology described herein. There may be significant variations between embodiments in relation to the other phases. An example embodiment of the address allocation phase 102 is described below by reference to FIG. 2A, from the context of processes performed by an example facilitator device.

In the example embodiment of FIG. 2A, method 200 includes execution of the following processes by the facilitator device, based on execution of software instructions maintained in memory of the facilitator device.

Method 200 follows from a trust establishment phase 101, from which a token or the like is shared thereby to enable trusted (and preferably encrypted) exchange of data between the initiator device and facilitator device during method 200.

Block 201 represents a process of receiving from an initiator device data representative of a first addressing data set, being, the first addressing data set being representative of network addresses that are available at the initiator device. In this example, this takes the form of an initiator device available subnet list, the initiator device available subnet list being representative of subnets that are available at the initiator device. This list may be defined by inclusion (i.e., a list of subnets currently not in use) or by exclusion (i.e., a list of subnets currently in use). In any case, this provides the facilitator device with an ability to determine a list of subnets that are available (i.e., not currently in use) at the initiator device.

Block 202 represents a process including accessing a second addressing data set, the second addressing data set being representative of network addresses that are available at the facilitator device. In this example, this takes the form of a facilitator device available subnet list, the facilitator device available subnet list being representative of subnets that are available at the facilitator device. This provides the facilitator device with an ability to determine a list of subnets that are available (i.e., not currently in use) at the facilitator device.

Block 203 represents a dynamic network address allocation process. This is performed thereby to determine a prescribed set of network addresses (in this example being IP addresses) for locking in respect of secure communications between the initiator device and the facilitator device. The prescribed set of network addresses (in this example being IP addresses) is determined based on processing of the first addressing data set and the second addressing data set. More specifically, one or more algorithms are executed thereby to identify a predefined number n of subnets that are available both at the initiator device and the facilitator device, and select a predefined number of those. For example, the algorithm may employ a numerical listing approach, whereby the first n subnets available at both the initiator device and the facilitator device are added to the prescribed list.

Block 204 represents locking the prescribed set of IP addresses for secure communications between the initiator device and the facilitator device. As such, those network addresses are no longer available at the facilitator device. Block 205 represents a process including communicating to the initiator device data representative of the prescribed set of IP addresses—in response the initiator device is configured to lock the prescribed set of IP addresses for secure communications between the initiator device and the facilitator device. As such, those network addresses are no longer available at the initiator device.

Software instructions at the initiator device configure the initiator device to commence secure communications with the facilitator device following receipt of the prescribed set of IP addresses. This may be achieved via a range of technologies, for example, via secure tunnelling approaches. Other secure communications approaches may be used, for example, a secured API or MQTT-like communicated request, a polling/curl/json/jwt endpoint that replies true/false as a request to join, or wired/wireless broadcast.

Block 206 represents a process whereby the facilitator device identifies that the initiator device has connected to the facilitator device via a secure communication based on the prescribed set of network addresses. This provides confirmation that the prescribed set of IP addresses was safely received and implemented by the initiator device. Block 207 represents that, in response to identifying that the initiator device has connected to the facilitator device via a secure communication based on the prescribed set of network addresses, that secure communications with the initiator device have been established via the prescribed set of network addresses.

Following block 207, the method progresses to secure communication phase 103. This, in some embodiments, includes revoking any tokens or the like that were exchanged during trust establishment phase 101 at the outset, and later upon the completion of secure communications, revoking the prescribed list of IP addresses. As a result, each time an initiator device initiates a process for secure communication with the facilitator device, the initiator device is required to re-perform the trust establishment phase, and receive a new prescribed set of IP addresses for the secure communications.

In some embodiments, logic is applied in the processes of block 203 to ensure that a prescribed set of IP addresses provided to a given initiator device has a degree of uniqueness compared to other prescribed sets provided to that initiator device, optionally being uniqueness in the context of a predefined preceding period (e.g., defined by reference to time and/or number of connection processes).

### Example Trust Establishment Phase

FIG. 2B illustrates an example of trust establishment phase 101, in the form of an initiator device method 210 and a facilitator device method 220. It should be appreciated that method 210 is a non-limiting example, with various embodiments of the technology described herein by reference to trust establishment phase 101 operating substantially agnostically of the manner by which trust establishment phase 101 is implemented.

Block 211 represents a trigger event, which causes the initiator device to issue a secure connection command to the facilitator device. This trigger process may take a range of forms, for example, including any one or more of the following:
A timer-driven trigger encoded in software at the initiator device.
A cron task (or similar) encoded in software at the initiator device.
Satisfaction of a rule or condition encoded in software at the initiator device.
The launching of a software application at the initiator device.
Identification by software executing at the initiator device of a signal from a cloud device (for example, a beacon or the like). This signal may be provided by the facilitator device, although it may also be provided by another device.

In response to the trigger event, the initiator device provides a secure connection request to the facilitator device at block 212, which is received by the facilitator device at block 221. Addressing information for the facilitator device is preferably encoded in software of the facilitator device, although it may also be received as part of the trigger event.

At block 222, the facilitator device responds with verifiable data, in this example being a public key for the facilitator device (such as a PKI public key or SSL Cert). This is received and verified by the initiator device at block 213. For example, in this embodiment the public key of the facilitator device is pre-encoded in software of the initiator device—this is compared against the public key that the facilitator device presents. This allows the initiator device to verify that the facilitator device is valid and trusted before communications are opened.

Assuming verification at block 213 is successful, block 214 represents an initiation process including an attempt to contact the gateway/endpoint (where the other end of the connection lives), which reaches an API endpoint at the facilitator device, at which the initiator device requests a new “connection.” This request is received and processed by the facilitator device at block 223. This preferably includes the facilitator device performs a check to verify the initiator device is permitted to connect (e.g., currently unblocked and allowed), for instance, using data such as IP address, UUID and/or a device fingerprint (and/or other identifying factors). This may include the use of a firewall at the facilitator device, which allows/declines the connection request.

Assuming the connection request is allowed by the facilitator device, at block 224 the facilitator device provides a token to the initiator device. This may be a limited use token—in the present example it is a one-time access token. However, it should be appreciated that in further embodiments, alternate approaches are used, for example, the pre-encoding of a static token at the initiator device.

The one-time access token is received by the initiator device at block 215. Following this, at block 225 the facilitator device provides to the initiator device an instruction (challenge) to decrypt and decode the token, which contains a single-use ‘step l’ credential set (received at block 216). That may take the form of a username/password, but is in other examples a one-time key or other verification system (it will be appreciated that the technology disclosed herein is generally agnostic to the particular implementation of this aspect). The single-use credentials are in this example added to the facilitator-side of the IPsec library, thus adding the initiator device as a “temporary account.” Credentials used for the initial authentication process are dropped accordingly, such that if the initiator device seeks to connect again (other than with the single-use credentials), the trust establishment phase re-starts.

In some embodiments, a response to the “challenge” provided to the facilitator device and validated as part of trust establishment phase 101. However, in this example that response process is bundled into the example of address allocation phase 102 described below by reference to FIG. 2C.

It should be appreciated that the above example of a trust establishment phase could be replaced by a range of other approaches, there being a wide range of known technologies that enable two devices on a network to establish trust and commence communications.

### Example Address Allocation Phase

FIG. 2C illustrates further example of address allocation phase 102, in the form of an initiator device method 230 and facilitator device method 240.

Block 231 represents a process whereby the initiator device completes the “challenge” presented by the facilitator device at block 225 of FIG. 2B. Substantially concurrently, the initiator device generates a list of all local subnets currently in use. This preferably includes all networks it is connected to (for instance, 192.168.0.0, 192.168.1.0, 10.0.0.0, and so on) as well as the subnet sizes (for instance, /24. /28, etc.). This is used to generate of an initiator device available subnet list, the initiator device available subnet list being representative of subnets that are available at the initiator device (representative in the sense that it designates “available” or “non-available” subnets).

The credentials decoded in response to the “challenge” of block 225, and the initiator device available subnet list are bundled up, and the client ‘logs in’ to the facilitator device using a temporary account provided via the one-time access token, and submits the challenge response and initiator device available subnet list (see block 232). This is received by the facilitator device at block 241.

At block 242, the facilitator device verifies the initiator device authenticity via the decoded credentials. Assuming that is successful, the facilitator device performs a dynamic IP allocation process at blocks 243-245. This includes:
Block 243: accessing the initiator device available subnet list.
Block 244: accessing a facilitator device available subnet list representative of subnets available at the facilitator device.
Block 245: processing the first and facilitator device available subnet lists, thereby to determines a block of IP addresses that are (in theory) available for use at both the initiator device and the client device.

This may include calculating the size of the initiator device network in use by processing the initiator device available subnet list (including size and number), thereby to determine all (or a limited selection of) IP addresses within the subnet list.

Block 246 represents a process of “locking” a prescribed list of IP addresses (which is optionally, but not necessarily, the smallest subnet/range of IP addresses identifiable), for example, by adding these to its network manager. These IP addresses are earmarked on the facilitator device for services like the Server IP (for the facilitator device), Client IP (for the initiator device), and Device NAT. Additional services may be earmarked such as firewall, antivirus, another API, etc., depending on the implementation context. In one example:
The first IP address in the subnet if designated as a facilitator device IP address.
The second IP address in the subnet if designated as an initiator device IP address.
A third IP address in the subnet if designated as a Device NAT.

At block 247 data representative of the prescribed IP addresses and the subnet size is then sent back upstream to the initiator device (for example, a message representing “use 192.168.5.16/29”), along with credentials for the resulting secures communications (e.g., tunnelling). This is received at block 233.

At block 234, the initiator device locks the relevant IP addresses (for example, by adding these to its network manager). The initiator device is preferable pre-encoded with logic to perform corresponding IP address purpose allocations (e.g., for Server IP, Client IP, Device NAT, and so on).

At blocks 235 and 248, the initiator device and facilitator device respectively have secure network IP addresses configured and ready for use at secure communications phase 103. This provides a unique network, in the sense that that there is negligible risk to collide with any other networks on the initiator device or facilitator device, mitigating the chance of IP collisions.

### Example Secure Communications Phase

FIG. 2D illustrates further example of secure communications phase 103, in the form of an initiator device method 250 and facilitator device method 260.

Block 251 represents a process whereby credentials provided by the facilitator device and the prescribed IP addresses within the network (client IP, server IP, NAT IP etc.) are added to a protocol library, in this example being the IPsec protocol library, which is responsible for the resulting secure connection via an appropriate secure connection protocol (for example, making use of secure tunnel technology). This provides for, in essence, “a one-time use VPN,” which optionally makes use of secure tunnelling libraries available on modern Windows and Unix (macOS, Linux) kernels. It will be appreciated that secure communications technologies are varied and continue to evolve, and that the present approach may be adapted accordingly.

Block 252 represents the initiator device commencing secure communications via the prescribed IP addresses, via the relevant secure connection protocol. This is identified by the facilitator device at block 261. Upon identifying connection via the prescribed IP addresses via the relevant secure connection protocol, the facilitator device optionally performs various processes, including to close-off permissions established via the trust establishment phase (if not completed previously)—see block 262. This may include revoking the single-use credentials. Thus, once the initiator device appears as connected to the facilitator device via the secure connection, the single-use and other preexisting credentials are no longer valid, meaning that if a 3rd party tried to redeem that connection, or a 3rd party pre-opens the connection with anticipation the initiator device will join too, either case will fail, optionally with an alert that the connection has already been redeemed/accessed and that the connection may be compromised.

Blocks 253 and 263 represent secure communication between the initiator device and the facilitator device, for example, as established tunneled devices. The nature of encryption used for the purposes of the secure communications varies between embodiments. By way of example, the following encryption technologies may be used:
Algorithms/Protocols that comply with US NIST standards on encrypted communications.
Custom encryption standards that are either new, in-research, or used in production.
Traditional Diffie-Hellman key exchange model.
Traditional hashed cryptographic method.
AES/SHA based cryptography.

Blocks 254 and 264 represent termination of secure communication between the initiator device and the facilitator device. Termination may occur at each device synchronously and/or asynchronously, and in response to different triggers. For example, triggers may include one or more of the following:
A termination message by the initiator device (for example, triggered by event-based rules).
A termination message by the facilitator device (for example, triggered by event-based rules).
A predefined connection time period completing (the predefined time period being encoded in either or both of the initiator device and the facilitator device).
A predefined time-out event, where the secure connection has not been used for a defined timeout period (the timeout period being encoded in either or both of the initiator device and the facilitator device).
An app being closed on the initiator device.
An event-based termination condition encoded in the facilitator device and/or the initiator device.
A notification that a third party is attempting to break into the communication. For example, this may be identified based on one or more of: abnormal network traffic being detected; the router/device being opened; either end having security certificates replaced (a man-in-the-middle condition); power/race conditions being invoked; and/or other criteria.
A third party attempting to re-use the single-use credentials or network parameters already in use.

Upon termination, the IP addresses used for the purposes of the secure communications are removed from the relevant protocol libraries at each of the initiator device and facilitator device, become available once again (for example, these could be used in the context of a subsequent address allocation phase)—see blocks 254 and 255. As a result, conducting of further secure communications requires recommencing the address allocation phase 102 (and, in examples where credentials established during the trust establishment phase 101 have been revoked, that requires commencing again with the trust establishment phase 101).

### CONCLUSIONS AND INTERPRETATION

The above technology provides significant advantages in the context of secure networked communications. In particular, two devices on a network (for example, the Internet) are able to connect and establish trust via a range of existing technologies, and upon trust being established, seamlessly transition to secure point-to-point communications (for example, via tunnelling). This is achieved in a manner that mitigates risks of communications being compromised, and inhibits access to the secure communications by malicious parties.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments, but only by the scope of the appended claims.

It should be appreciated that in the above description of exemplary embodiments of the present disclosure, various features of the present disclosure are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of the present disclosure.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the present disclosure.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B, which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

What is claimed is:

1. A method for enabling secure communications between an initiator device and a facilitator device, the method including execution of the following processes by the facilitator device:
receiving, from the initiator device, data representative of a first addressing data set, the first addressing data set being representative of network addresses that are available at the initiator device;
accessing a second addressing data set, the second addressing data set being representative of network addresses that are available at the facilitator device;
performing a dynamic network address allocation process thereby to determine a prescribed set of network addresses for locking in respect of secure communications between the initiator device and the facilitator device, wherein the prescribed set of network addresses is determined based on processing of the first addressing data set and the second addressing data set;
locking the prescribed set of network addresses for secure communications between the initiator device and the facilitator device, such that those network addresses are no longer available at the facilitator device;
communicating to the initiator device data representative of the prescribed set of IP addresses;
identifying that the initiator device has connected to the facilitator device via a secure communication based on the prescribed set of network addresses; and
in response to identifying that the initiator device has connected to the facilitator device via a secure communication based on the prescribed set of network addresses, establishing secure communications with the initiator device via the prescribed set of network addresses.

2. The method of claim 1, wherein the initiator device initially connects to the facilitator device via a limited use access token, and wherein the method additionally includes: upon identifying that the initiator device has connected to the facilitator device via a secure tunnel based on the prescribed set of IP addresses, revoking the limited use access token.

3. The method of claim 1, wherein the step of performing a dynamic network address allocation process thereby to determine a prescribed set of network addresses for locking in respect of secure communications between the initiator device and the facilitator device, wherein the prescribed set of network addresses is determined based on processing of the first addressing data set and the second addressing data set, incudes identifying a set of network addresses that are concurrently available for use at both the initiator device and the facilitator device.

4. The method of claim 1, wherein the network addresses are IP addresses.

5. The method of claim 4, wherein the: first addressing data set is a first subnet list, the first subnet list being representative of subnets that are available at the initiator device; and the second addressing data set, is a second subnet list being representative of subnets that are available at the facilitator device.

6. The method of claim 1, further comprising a trust establishment phase, wherein the facilitator device receives data from the initiator device and performs a determination to trust the initiator device.

7. The method of claim 6, wherein the trust establishment phase includes verifying an access token in a communication provided by the initiator device to the facilitator device.

8. The method of claim 7, wherein the access token is a limited use access token.

9. The method of claim 8, wherein the method includes: upon identifying that the initiator device has connected to the facilitator device via a secure tunnel based on the prescribed set of IP addresses, revoking the limited use access token.

10. The method of claim 1, further comprising at step of terminating the secure communication between the initiator device and the facilitator device, the step of terminating including unlocking the prescribed set of network addresses, such that those network addresses become available at the facilitator device.

11. A method for enabling secure communications between an initiator device and a facilitator device, the method including execution of the following processes by the initiator device:
providing, to the initiator device, data a representative of a first addressing data set, the first addressing data set being representative of network addresses that are available at the initiator device, wherein in response to receiving the first addressing data set the facilitator device performs the following processes: accessing a second addressing data set, the second addressing data set being representative of network addresses that are available at the facilitator device; performing a dynamic network address allocation process thereby to determine a prescribed set of network addresses for locking in respect of secure communications between the initiator device and the facilitator device, wherein the prescribed set of network addresses is determined based on processing of the first addressing data set and the second addressing data set; and locking the prescribed set of network addresses for secure communications between the initiator device and the facilitator device, such that those network addresses are no longer available at the facilitator device;
receiving, from the facilitator device, data representative of the prescribed set of IP addresses;
locking the prescribed set of network addresses for secure communications between the initiator device and the facilitator device, such that those network addresses are no longer available at the initiator device; and
commencing secure communication with the facilitator device based on the prescribed set of network addresses.

12. The method of claim 11, wherein the initiator device initially connects to the facilitator device via a limited use access token, and wherein the method additionally includes: upon identifying that the initiator device has connected to the facilitator device via a secure tunnel based on the prescribed set of IP addresses, revoking the limited use access token.

13. The method of claim 11, wherein the step of performing a dynamic network address allocation process thereby to determine a prescribed set of network addresses for locking in respect of secure communications between the initiator device and the facilitator device, wherein the prescribed set of network addresses is determined based on processing of the first addressing data set and the second addressing data set, incudes identifying a set of network addresses that are concurrently available for use at both the initiator device and the facilitator device.

14. The method of claim 11, wherein the network addresses are IP addresses.

15. The method of claim 14, wherein the: first addressing data set is a first subnet list, the first subnet list being representative of subnets that are available at the initiator device; and the second addressing data set, is a second subnet list being representative of subnets that are available at the facilitator device.

16. The method of claim 11, further comprising a trust establishment phase, wherein the facilitator device receives data from the initiator device and performs a determination to trust the initiator device.

17. The method of claim 16, wherein the trust establishment phase includes verifying an access token in a communication provided by the initiator device to the facilitator device.

18. The method of claim 17, wherein the access token is a limited use access token.

19. The method of claim 18, wherein the method includes: upon identifying that the initiator device has connected to the facilitator device via a secure tunnel based on the prescribed set of IP addresses, revoking the limited use access token.

20. The method of claim 11, further comprising at step of terminating the secure communication between the initiator device and the facilitator device, the step of terminating including unlocking the prescribed set of network addresses, such that those network addresses become available at the facilitator device.
